(19) United States
(12) Patent Application Publication
(10) Pub. No.: US 2013/0136936 A1
(43) Pub. Date: May 30, 2013

(54) GAS BARRIER BASE MATERIAL AND GAS BARRIER LAMINATE

(71) Applicant: Sony Corporation, Tokyo (JP)

(72) Inventors: Takeshi Morozumi, Miyagi (JP); Tomoo Fukuda, Miyagi (JP); Takuji Matsuo, Miyagi (JP); Sung-kil Lee, Miyagi (JP)

(73) Assignee: Sony Corporation, Tokyo (JP)

(21) Appl. No.: 13/684,706

(22) Filed: Nov. 26, 2012

(30) Foreign Application Priority Data
Nov. 29, 2011 (JP) 2011-260769

(51) Int. Cl. B32B 15/08; B32B 27/06

(52) U.S. Cl. CPC B32B 15/08; B32B 27/06
USPC 428/500; 428/688; 428/702

(57) ABSTRACT

A gas barrier base material includes a base material, a resin layer disposed on at least one principal surface of the base material, and an inorganic oxide layer which is disposed on one principal surface of the resin layer and which contains an inorganic oxide, wherein the resin layer is produced by curing a resin composition containing a polymerizable compound having a cycloalkane structure or a polymerizable compound having a high-acid value phthalic acid structure.

### BACKGROUND

The present disclosure relates to a gas barrier base material and a gas barrier laminate.

A gas barrier film to block gases, e.g., a water vapor, by forming a metal oxide on a film is used for next-generation displays, e.g., organic EL, solar cells, packaging materials for high technology medical care and drugs, and various electronic devices, e.g., electronic paper and solar cells. Various films have been studied as such a gas barrier film (refer to, for example, Japanese Unexamined Patent Application Publication No. 2010-30292, Japanese Unexamined Patent Application Publication No. 2010-30290, Japanese Unexamined Patent Application Publication No. 2010-89502, Japanese Unexamined Patent Application Publication No. 2009-172988, Japanese Unexamined Patent Application Publication No. 2010-30286, Japanese Unexamined Patent Application Publication No. 2009-18569, Japanese Unexamined Patent Application Publication No. 2009-95989, and Japanese Unexamined Patent Application Publication No. 2010-6064).

### SUMMARY

In the technical field of the present disclosure, further improvement in gas barrier property has been desired.

Therefore, it is desirable to provide a gas barrier base material and a gas barrier laminate, wherein the gas barrier property is improved.

A gas barrier base material according to an embodiment of the present disclosure includes a base material, a resin layer disposed on at least one principal surface of the base material, and an inorganic oxide layer which is disposed on one principal surface of the resin layer and which contains an inorganic oxide, wherein the resin layer is produced by curing a resin composition containing a polymerizable compound having a cycloalkane structure or a polymerizable compound having a high-acid value phthalic acid structure.

A gas barrier laminate according to an embodiment of the present disclosure includes a resin layer and an inorganic oxide layer which is disposed on one principal surface of the resin layer and which contains an inorganic oxide, wherein the resin layer is produced by curing a resin composition containing a polymerizable compound having a cycloalkane structure or a polymerizable compound having a high-acid value phthalic acid structure.

In the configuration according to embodiments of the present disclosure, the resin layer is produced by curing a resin composition containing a polymerizable compound having a cycloalkane structure or a polymerizable compound having a high-acid value phthalic acid structure. The adhesion (affinity) between the inorganic oxide layer and the resin layer is good because of this configuration, and, thereby, the gas barrier property is improved.

According to embodiments of the present disclosure, the gas barrier property is improved.

### BRIEF DESCRIPTION OF THE DRAWINGS

FIG. 1 is a sectional view showing a configuration example of a gas barrier film according to an embodiment of the present disclosure;

FIG. 2 is a SEM image of an alumina film in Example 1;

FIG. 3A shows an ESCA spectrum in Example 1-1 and FIG. 3B shows an ESCA spectrum in Comparative example 1-1; and

FIGS. 4A and 4B are bar graphs showing measurement results of surface roughness collectively.

### DETAILED DESCRIPTION OF EMBODIMENTS

The embodiments according to the present disclosure will be described below with reference to the drawings. The explanations are performed in the following order.

1. One embodiment (example of gas barrier base material)

2. Other embodiments (modified examples)

### 1. One Embodiment

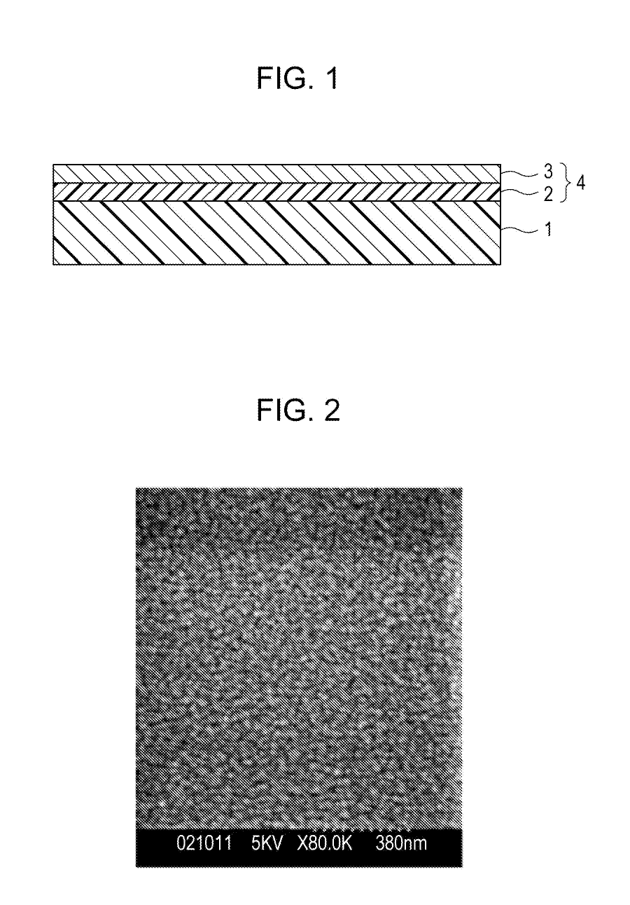

A gas barrier base material according to an embodiment of the present disclosure will be described. FIG. 1 is a sectional view showing a gas barrier base material according to an embodiment of the present disclosure. As shown in FIG. 1, this gas barrier base material includes a base material 1 and a gas barrier laminate 4 disposed on one principal surface of the base material 1. The gas barrier laminate 4 includes a resin layer 2 disposed on the one principal surface of the base material 1 and an inorganic oxide layer 3 stacked on the resin layer 2. The example shown in FIG. 1 has a configuration in which the gas barrier laminate 4 is disposed on the one principal surface of the base material 1, although the gas barrier laminates 4 may be disposed on both principal surfaces of the base material 1.

Base Material

Polymer materials in the related art, e.g., plastic materials in the related art, may be used as the material for the base material 1. Concrete examples of polymer materials in the related art include polyethylene naphthalate (PEN), polyethylene terephthalate (PET), triacetyl cellulose (TAC), polyester (TPEE), polyimide (PI), polyamide (PA), aramid, polyethylene (PE), polyacrylate, polyethersulfone, polysulfone, polypropylene (PP), diacetyl cellulose, polyvinyl chloride, acrylic resin (PMMA), polycarbonate (PC), epoxy resin, urea resin, urethane resin, and melamine resin. Examples of shapes of the base material 1 may include the shapes of a film, a plate, and a block, although not specifically limited to them. The shape of a film is specified to include the shape of a sheet. Typical examples of gas barrier base materials include a gas barrier film by using a plastic film made from a film-shaped plastic material as the base material 1. Among the base materials 1, a polyethylene naphthalate (PEN) film is preferable because of good surface smoothness.

Resin Layer

The resin layer 2 is produced by curing a resin composition including a resin material containing a polymerizable compound having a cycloalkane structure or a polymerizable compound having a high-acid value phthalic acid structure, a solvent, and as necessary an additive, an initiator, and the like. The gas barrier laminate 4 formed from the resin layer 2 and the inorganic oxide layer 3 has excellent adhesion to the base material 1 and gas barrier property. The thickness of the resin layer 2 is not specifically limited. Typically, the thickness is specified to be, for example, several tens of nanometers or more and several micrometers or less, and more concretely, for example, 50 nm or more and 2,000 nm or less.

Resin Composition

Resin Material

The resin material contains a polymerizable compound having a cycloalkane structure or a polymerizable compound having a high-acid value phthalic acid structure.

Polymerizable compound having cycloalkane structure

The polymerizable compound having a cycloalkane structure is a compound having a cycloalkane structure and at least one photopolymerizable functional group. Examples of photopolymerizable functional groups include an acryloyl group and a methacryloyl group. Typically, the polymerizable compound having a cycloalkane structure is an acrylate having a cycloalkane structure which has a cycloalkane structure and at least one acryloyl group. The cycloalkane structures also include oxygen-containing hydrocarbon ring structures formed from hydrocarbon and oxygen besides ring structures formed from only hydrocarbon. The ring structures include a single ring structure, a bridged-ring structure, and a spiro ring structure.

Examples of polymerizable compounds having a cycloalkane structure include polymerizable compounds represented by General formula (A).

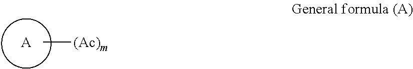

In the formula, A represents an aliphatic hydrocarbon ring which may contain oxygen, the aliphatic hydrocarbon ring may have a substituent, Ac represents a photopolymerizable functional group, and m represents 1 or 2.

In General formula (A), the aliphatic hydrocarbon ring which may contain oxygen may be a single ring, a bridged ring, or a spiro ring. The photopolymerizable functional group is, for example, an acryloyl group or a methacryloyl group.

Examples of polymerizable compounds represented by General formula (A) include acrylates represented by Formula (1), acrylates represented by Formula (2), and acrylates represented by Formula (3).

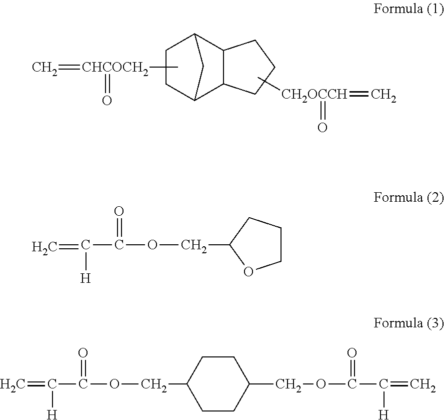

Polymerizable Compound Having High-Acid Value Phthalic Acid Structure

The polymerizable compound having a high-acid value phthalic acid structure is a compound which has a high acid value and which has a phthalic acid structure and at least one photopolymerizable functional group. Examples of photopolymerizable functional groups include an acryloyl group and a methacryloyl group. Typically, the polymerizable compound having a high-acid value phthalic acid structure is an acrylate having a high-acid value phthalic acid structure which has a high acid value and which has a phthalic acid structure and at least one acryloyl group. Examples thereof include acrylates represented by General formula (B). The acid value refers to the amount (mg) of KOH to neutralize 1 g of resin and, typically, the high acid value refers to acid values of, for example, 180 mgKOH/g or more and 200 mgKOH/g or less.

Examples of polymerizable compounds having a high-acid value phthalic acid structure include polymerizable compound represented by General formula (B).

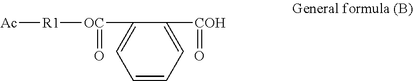

In the formula, R1 represents a divalent hydrocarbon group having the carbon number of 1 to 3 and Ac represents a photopolymerizable functional group.

In General formula (B), the divalent hydrocarbon group having the carbon number of 1 to 3 is, for example, a methylene group, an ethylene group, or an isopropylene group. The photopolymerizable functional group is, for example, an acryloyl group or a methacryloyl group.

Examples of polymerizable compounds represented by General formula (B) include compounds represented by Formula (4).

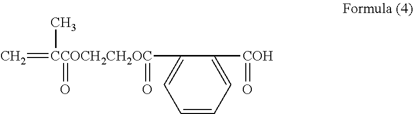

Additive

The resin composition may contain an additive to improve the smoothness of the resin layer 2. A phosphoric acid acrylate may be used as the additive. Examples of phosphoric acid acrylates include acrylates represented by Formula (5).

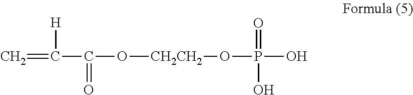

Initiator

The resin composition may contain a polymerization initiator. Examples of polymerization initiators include Irgacure 184, Irgacure 127, and the like commercially available from Ciba Specialty Chemicals and Esacure series (for example, 2-hydroxy-2-methyl-[4-(1-methylvinyl)phenyl]propanol oligomer (ESACURE-ONE) and oligomer type Esacure KIP series (Esacure KIP 150 and the like)) commercially available from Lamberti. Among them, low-volatile Irgacure 127 represented by Formula (6) and ESACURE-ONE and Esacure KIP 150 represented by Formula (7) are preferable. ESACURE-ONE and Esacure KIP 150 represented by Formula (7) are more preferable. This is because the resin layer 2 more excellent in smoothness is formed and the gas barrier property is further improved.

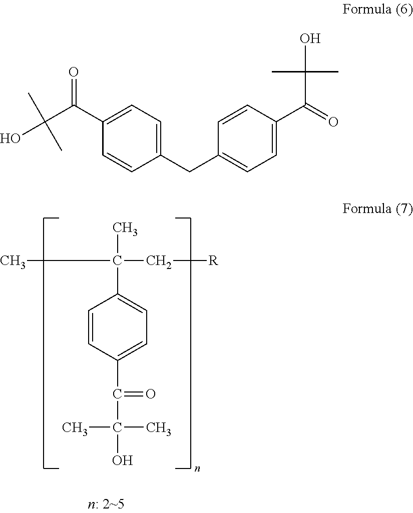

In the formula, R represents an ethyl group.

Solvent

A solvent which can dissolve a resin raw material, e.g., an acrylate, to be used is employed. Examples of such solvents include ketones or carboxylic acid esters, e.g., acetone, diethyl ketone, dipropyl ketone, methyl ethyl ketone, methyl butyl ketone, methyl isobutyl ketone, cyclohexanone, methyl formate, ethyl formate, propyl formate, isopropyl formate, butyl formate, methyl acetate, ethyl acetate, propyl acetate, isopropyl acetate, butyl acetate, isobutyl acetate, secondary butyl acetate, amyl acetate, isoamyl acetate, secondary amyl acetate, methyl propionate, ethyl propionate, methyl butylate, ethyl butylate, and methyl lactate, alcohols, e.g., methanol, ethanol, isopropanol, n-butanol, sec-butanol, and tert-butanol, and ethers, e.g., tetrahydrofuran, 1,4-dioxane, and 1,3-dioxolane. These solvents may be used alone or mixtures of at least two components may be used. Furthermore, solvents other than those described above may be added within the bound of not impairing the performance of the resin raw material.

Inorganic Oxide Layer

The inorganic oxide layer 3 is, for example, a thin metal oxide film containing a metal oxide. The metal oxide film is, for example, an amorphous metal oxide film. The inorganic oxide layer 3 is a layer containing an inorganic oxide as a primary component and having gas barrier properties, e.g., a water vapor barrier property and an oxygen barrier property, to block components e.g., water and oxygen, present in the outside air. Examples of metal oxides include oxides containing at least one type of metal element selected from the group consisting of Al, In, Si, Sn, Zn, Ti, Cu, Ce, and Ta. They may contain other elements as secondary components. More concretely, for example, alumina (Al₂O₃) is mentioned. The thickness of the inorganic oxide layer 3 is not specifically limited and typically is specified to be, for example, 5 nm or more and 1,000 nm or less.

Method for Manufacturing Gas Barrier Base Material

The above-described resin composition is applied to the base material 1 and is dried. The method for applying the resin composition is not specifically limited and a coating method in the related art may be used. Examples of coating methods in the related art include a micro gravure coating method, a wire bar coating method, a direct gravure coating method, a die coating method, a dipping method, a spray coating method, a reverse roll coating method, a curtain coating method, a comma coating method, a knife coating method, and a spin coating method.

Curing

The resin composition is irradiated with light so as to be cured. Consequently, the resin layer 2, which is a cured resin composition, is obtained on the base material 1. More concretely, the dried resin composition on the base material 1 is cured by, for example, application of ionizing radiation. For example, electron beams, ultraviolet rays, visible light, and gamma rays are used as the ionizing radiation. From the viewpoint of production facilities, ultraviolet rays are preferable. Preferably, the cumulative amount of irradiation is selected appropriately in consideration of the curing characteristics of the resin composition, suppression of yellowing of the resin composition and the base material, and the like. Preferably, the atmosphere of irradiation is selected appropriately in accordance with the type of the resin composition and examples thereof include atmospheres of air and inert gases, e.g., nitrogen and argon.

Inorganic Oxide Layer

The inorganic oxide layer 3 of, for example, a thin film of a metal oxide is formed on the resin layer 2, which is the cured resin composition. The thin film may be formed by a vapor phase method, for example, a physical vapor deposition (PVD) method or a chemical vapor deposition (CVD) method. Alternatively, the film may be formed by a liquid phase method, e.g., electroplating, electroless plating, a coating method, or a sol-gel method. The film may also be formed by a solid method, e.g., a solid phase epitaxy (SPE) method or a Langmuir-Blodgett (LB) method. The PVD method is a method in which a raw material for forming a thin film is evaporated and vaporized once by energy, e.g., heat or plasma, and a thin film is formed on a substrate. Examples of PVD methods include a vacuum evaporation method, a sputtering method, an ion plating method, a molecular beam epitaxy (MBE) method, and a laser abrasion method. The CVD method is a method in which a constituent material of a thin film is supplied as a gas, a raw material gas molecule is decomposed and reacted to form an intermediate product by applying energy, e.g., heat, light, or plasma, and a thin film is accumulated through adsorption on the substrate surface, reaction, and desorption. Examples of CVD methods include a thermal CVD method, a metal organic chemical vapor deposition (MOCVD) method, a RF plasma CVD method, a photo-CVD method, a laser CVD method, and a liquid phase epitaxy (LPE) method. In this manner, the gas barrier base material according to an embodiment of the present disclosure may be obtained.

Device Including Gas Barrier Base Material

The gas barrier base material according to an embodiment of the present disclosure is favorably used for a device in order to prevent the device from being degraded by chemical components in the air. Examples of such devices include electronic devices, e.g., electronic paper, liquid crystal display apparatuses, thin film transistors, and touch panels.

### EXAMPLES

Concrete examples according to the embodiments of the present disclosure will be described in detail. However, the present disclosure is not limited to them.

### Example 1

### Preparation of Paint

A resin composition paint was prepared by mixing the individual components of a resin composition and a solvent described below. In preparation of the paint, the solid content was adjusted to become 30 percent by mass. The solid content refers to all components constituting a resin layer after curing. Concretely, for example, a resin material, an additive, a photopolymerization initiator, and the like are included in the solid content.

Resin Composition

Resin material: DCPA (SR833 produced by Sartomer Company Inc., the structural formula is as described below), content: 95 percent by mass

Initiator: Irgacure 184 (Irg184) (1-hydroxy-cyclohexyl-phenyl-ketone, produced by Ciba Specialty Chemicals, the structural formula is as described below), content: 5 percent by mass

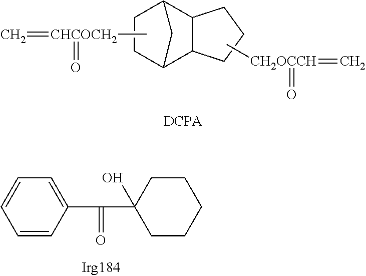

Solvent: mixed solvent of cyclohexanone and butyl acetate (mixing ratio 1:1 (mass ratio))

Formation of Resin Layer

The paint having a coating thickness of about 2 to 3 μm was applied to one principal surface of a polyethylene naphthalate (PEN) film base material (Q65F, produced by Teijin DuPont films Japan Limited) with a bar coater. Thereafter, drying was performed in an oven at 80° C. for 2 minutes, and curing was performed through UV irradiation (Fusion, L/S=5 m/min, 300 mJ/cm²). Consequently, a resin layer was formed.

Formation of Alumina Film

Then, 50 nm of alumina film was formed on the resin layer through sputtering under the following condition. In this manner, a gas barrier film of Example 1 was obtained.

Sputtering Condition

Sputtering apparatus (C-3103, produced by Canon-Anelva)

Sputtering target material: Al₂O₃

Target size: 150 mm diameter×5 mmt

Sputtering system: RF magnetron

RF input power: 500 W

Ar gas flow rate: 100 sccm

Sputtering gas pressure: 0.53 Pa

Sputtering time: 3050 sec (sputtering film thickness 50 nm)

Ultimate degree of vacuum (background pressure): about 5×10⁻⁵ Pa

Temperature: room temperature

Evaluation

The gas barrier film of Example 1 was subjected to “surface roughness measurement”, “water vapor permeability measurement”, and “SEM observation”, as described below.

Surface Roughness Measurement

The arithmetic average roughness (Ra) and the maximum height (Rz) in 140×105 μm were determined with a noncontact three-dimensional roughness meter New View 5000 by Zygo. The Ra and the Rz in 1×1 μm were measured by using SPM (Nano Scope IIIa/D-3000, Digital Instruments).

The measurement results are as described below.

Measurement Results

Before formation of alumina film:
Ra: 0.50 nm, Rz: 4.41 nm (140×105 μm)
Ra: 3.39 nm, Rz: 5.00 nm (1×1 μm)

After formation of alumina film:
Ra: 1.07 nm, Rz: 9.66 nm (140×105 μm)
Ra: 0.59 nm, Rz: 5.40 nm (1×1 μm)

Water Vapor Permeability Measurement

The measurement was performed under the condition of 40° C. and a relative humidity of 90% by using a water vapor permeation apparatus (model 7002) produced by Illinoi as a water vapor permeability measuring apparatus. According to the measurement results, the values were smaller than the measurement limit value of 0.001 g/m²/day of the measuring apparatus. A PEN film base material was subjected to the measurement in the same manner for reference purposes. The result was 1.8 g/m²/day.

SEM Observation

An alumina film was observed with SEM (FE-SEM: field emission-scanning electron microscope) at an accelerating voltage of 5 kV, an observation magnification of ×80 k, and Pt—Pd sputtering (4 nm). FIG. 2 shows a SEM image. As shown in FIG. 2, it was ascertained that an amorphous aluminum film was formed on the resin layer.

### Example 1-1

### Preparation of Paint

A paint was prepared by mixing the individual components of a resin composition and a solvent described below. In preparation of the paint, the solid content was adjusted to become 15 percent by mass.

Resin Composition

Resin material: DCPA (SR833 produced by Sartomer Company Inc.), content: 95 percent by mass

Initiator: Irg184 (1-hydroxy-cyclohexyl-phenyl-ketone, produced by Ciba Specialty Chemicals), content: 5 percent by mass

Solvent: mixed solvent of cyclohexanone and butyl acetate (mixing ratio 1:1 (mass ratio))

Formation of Resin Layer

The paint having a coating thickness of about 5 μm was applied to one principal surface of a polyethylene naphthalate (PEN) film base material (Q65F, produced by Teijin DuPont films Japan Limited) with a bar coater. Thereafter, drying was performed in an oven at 80° C. for 2 minutes, and curing was performed through UV irradiation (Fusion, L/S=5 m/min, 300 mJ/cm²). Consequently, a resin layer was formed.

Formation of Alumina Film

Then, 10 nm of alumina film was formed on the resin layer through sputtering. In this manner, a gas barrier film of Example 1-1 was obtained.

Sputtering Condition

Sputtering apparatus (C-3103, produced by Canon-Anelva)

Sputtering target material: Al₂O₃

Target size: 150 mm diameter×5 mmt

Sputtering system: RF magnetron

RF input power: 500 W

Ar gas flow rate: 100 sccm

Sputtering gas pressure: 0.53 Pa

Sputtering time: 610 sec (sputtering film thickness 10 nm, 0.985 nm in terms of sputtering rate)

Ultimate degree of vacuum (background pressure): about 5×10⁵ Pa

Temperature: room temperature

### Example 1-2

A gas barrier film was obtained in the same manner as in Example 1-1 except that the resin composition described below was employed.

Resin Composition

Resin material: 2-methacryloyloxyethyl phthalic acid (CB-1, produced by SHIN-NAKAMURA CHEMICAL CO., LTD., the structural formula is as described below, acid value 197 mgKOH/g), content: 95 percent by mass

Initiator: Irg184, content: 5 percent by mass

Solvent: mixed solvent of cyclohexanone and butyl acetate (mixing ratio 1:1 (mass ratio))

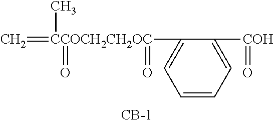

### Example 2-1

A gas barrier film was obtained in the same manner as in Example 1-1 except that the resin composition described below was employed.

Resin Composition

Resin material: DCPA+2-acryloyloxyethyl acid phosphate (P-1A, produced by Kyoeisha Chemical Co., Ltd., the structural formula is as described below), content: 95 percent by mass

Initiator: Irg184, content: 5 percent by mass

Solvent: mixed solvent of cyclohexanone and butyl acetate (mixing ratio 1:1 (mass ratio))

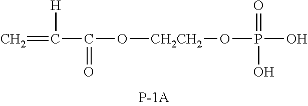

### Example 2-2

A gas barrier film was obtained in the same manner as in Example 1-1 except that the resin composition described below was employed.

Resin Composition

Resin material: CB-1, content: 95 percent by mass +additive: P-1A, content 0.1 percent by mass

Initiator: Irg184, content: 5 percent by mass

Solvent: mixed solvent of cyclohexanone and butyl acetate (mixing ratio 1:1 (mass ratio))

### Example 2-3

A gas barrier film was obtained in the same manner as in Example 1-1 except that the resin composition described below was employed.

Resin Composition

Resin material: DCPA, content: 95 percent by mass

Initiator: Irgacure 127 (Irg127) (2-hydroxy-1-{4-[4-(2-hydroxy-2-methyl-propionyl)-benzyl]phenyl}-2-methyl-propan-1-one, produced by Ciba Specialty Chemicals, the structural formula is as described below), content: 5 percent by mass

Solvent: mixed solvent of cyclohexanone and butyl acetate (mixing ratio 1:1 (mass ratio))

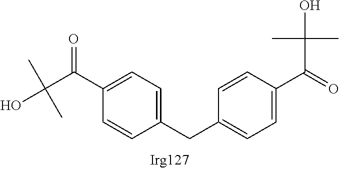 [SMILES: CC(C)(O)C(=O)c1ccc(Cc2ccc(C(=O)C(C)(C)O)cc2)cc1]

### Example 2-4

A gas barrier film was obtained in the same manner as in Example 1-1 except that the resin composition described below was employed.

Resin Composition

Resin material: DCPA, content: 95 percent by mass

Initiator: Esacure KIP 150 (the structural formula is as described below), content: 5 percent by mass

Solvent: mixed solvent of cyclohexanone and butyl acetate (mixing ratio 1:1 (mass ratio))

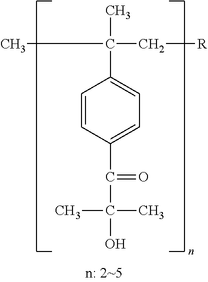

In the formula, R represents an ethyl group.

### Example 2-5

A gas barrier film was obtained in the same manner as in Example 1-1 except that the resin composition described below was employed.

Resin Composition

Resin material: DCPA, content: 95 percent by mass

Initiator: ESACURE-ONE (oligo{2-hydroxy-2-methyl-1-[4-(1-methylvinyl)phenyl]propanone}, produced by DKSH, the structural formula is as described below), content: 5 percent by mass

Solvent: mixed solvent of cyclohexanone and butyl acetate (mixing ratio 1:1 (mass ratio))

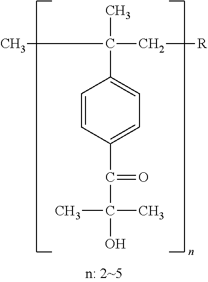

In the formula, R represents an ethyl group.

### Example 2-6

A gas barrier film was obtained in the same manner as in Example 1-1 except that the resin composition described below was employed.

Resin Composition

Resin material: tetrahydrofurfuryl acrylate (SR285, produced by Sartomer Company Inc., the structural formula is as described below), content: 95 percent by mass

Initiator: ESACURE-ONE, content: 5 percent by mass

Solvent: mixed solvent of cyclohexanone and butyl acetate (mixing ratio 1:1 (mass ratio))

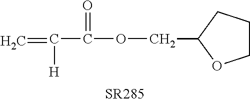

### Example 2-7

A gas barrier film was obtained in the same manner as in Example 1-1 except that the resin composition described below was employed.

Resin Composition

Resin material: cyclohexane dimethanol diacrylate (CD406, produced by Sartomer Company Inc., the structural formula is as described below), content: 95 percent by mass

Initiator: ESACURE-ONE, content: 5 percent by mass

Solvent: mixed solvent of cyclohexanone and butyl acetate (mixing ratio 1:1 (mass ratio))

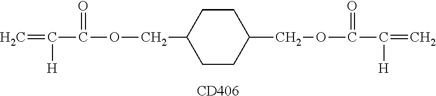

### Comparative Example 1-1

A gas barrier film was obtained in the same manner as in Example 1-1 except that the resin composition described below was employed.

Resin Composition

Resin material: trimethylolpropane triacrylate (TMPTA, produced by SHIN-NAKAMURA CHEMICAL CO., LTD., the structural formula is as described below), content: 95 percent by mass

Initiator: Irg184, content: 5 percent by mass

Solvent: mixed solvent of cyclohexanone and butyl acetate (mixing ratio 1:1 (mass ratio))

CH₃—CH₂—C(CH₂OOC—CH═CH₂)₃ TMPTA

### Comparative example 1-2

A gas barrier film was obtained in the same manner as in Example 1-1 except that the resin composition described below was employed.

Resin Composition

Resin material: pentaerythritol tetraacrylate (TMMT, produced by SHIN-NAKAMURA CHEMICAL CO., LTD., the structural formula is as described below), content: 95 percent by mass

Initiator: Irg184, content: 5 percent by mass

Solvent: mixed solvent of cyclohexanone and butyl acetate (mixing ratio 1:1 (mass ratio))

CCH₂OOC—CH═CH₂)₄ TMMT

### Comparative Example 1-3

A gas barrier film was obtained in the same manner as in Example 1-1 except that the resin composition described below was employed.

Resin Composition

Resin material: aromatic urethane acrylate (CN997, produced by Sartomer Company Inc.), content: 95 percent by mass

Initiator: Irg184, content: 5 percent by mass

Solvent: mixed solvent of cyclohexanone and butyl acetate (mixing ratio 1:1 (mass ratio))

### Comparative Example 1-4

A gas barrier film was obtained in the same manner as in Example 1-1 except that the resin composition described below was employed.

Resin Composition

Resin material: isocyanuric acid EO modified diacrylate (M215, produced by TOAGOSEI Co., Ltd., the structural formula is as described below), content: 95 percent by mass

Initiator: Irg184, content: 5 percent by mass

Solvent: mixed solvent of cyclohexanone and butyl acetate (mixing ratio 1:1 (mass ratio))

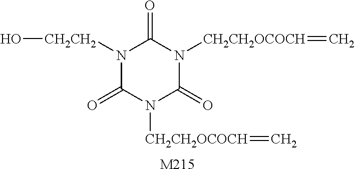

### Comparative Example 1-5

A gas barrier film was obtained in the same manner as in Example 1-1 except that the resin composition described below was employed.

Resin Composition

Resin material: ethoxylated bisphenol A diacrylate 2.2bis[4-(acryloxy polyethoxy)phenyl]propane (EO 3 mol) (ABE-300, produced by SHIN-NAKAMURA CHEMICAL CO., LTD., the structural formula is as described below), content: 95 percent by mass

Initiator: Irg184, content: 5 percent by mass

Solvent: mixed solvent of cyclohexanone and butyl acetate (mixing ratio 1:1 (mass ratio))

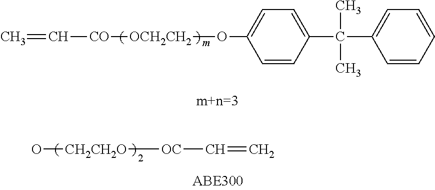

### Comparative Example 1-6

A gas barrier film was obtained in the same manner as in Example 1-1 except that the resin composition described below was employed.

Resin Composition

Resin material: 9,9-bis[4-(2-acryloyloxyethoxy)phenyl]fluorene (A-BPEF, produced by SHIN-NAKAMURA CHEMICAL CO., LTD., the structural formula is as described below), content: 95 percent by mass

Initiator: Irg184, content: 5 percent by mass

Solvent: mixed solvent of cyclohexanone and butyl acetate (mixing ratio 1:1 (mass ratio))

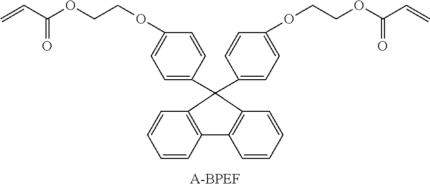 [SMILES: C=CC(=O)OCCOc1ccc(C2(c3ccc(OCCOC(=O)C=C)cc3)c3ccccc3-c3ccccc32)cc1]

### Comparative Example 1-7

A gas barrier film was obtained in the same manner as in Example 1-1 except that the resin composition described below was employed.

Resin Composition

Resin material: 2,2,2-trisacryloyloxymethylethyl phthalate (CBX-1N, produced by SHIN-NAKAMURA CHEMICAL CO., LTD., the structural formula is as described below, acid value 87 mgKOH/g), content: 95 percent by mass

Initiator: Irg184, content: 5 percent by mass

Solvent: mixed solvent of cyclohexanone and butyl acetate (mixing ratio 1:1 (mass ratio))

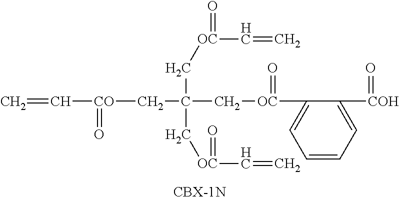

Evaluation

Adhesion

The adhesion of the gas barrier laminate (resin layer +metal oxide layer) produced in each of examples (Examples 1-1 to 2-7) and comparative examples (Comparative examples 1-1 to 1-7) was evaluated by a lattice pattern (100 squares, each 1 mm×1 mm) cellophane tape CT 24 (produced by Nichiban Co., Ltd.) peel test on the basis of JIS K5400. The criteria were expressed in the number of squares with no peeling among 100 squares (the number of squares with no peeling/100). In the case where the gas barrier laminate was not peeled (that is, the case of 100/100), the adhesion was evaluated as OK. In the gas barrier films of all examples and comparative examples, the results were “100/100” and, therefore, the adhesion of each gas barrier laminate was good.

Optical Characteristics

HAZE, total light transmittance

The HAZE (JIS K7136) and the total light transmittance Tt (JIS K7361) of the PEN film provided with the resin layer and produced in each of examples and comparative examples were evaluated with HM-150 (produced by MURAKAMI COLOR RESEARCH LABORATORY). In all examples and comparative examples, the resulting values were equivalent to the HAZE (<1%) and the total light transmittance (>90%) of the PEN film alone and, therefore, optical characteristics due to formation of the resin layer were not observed.

Surface Analysis with ESCA

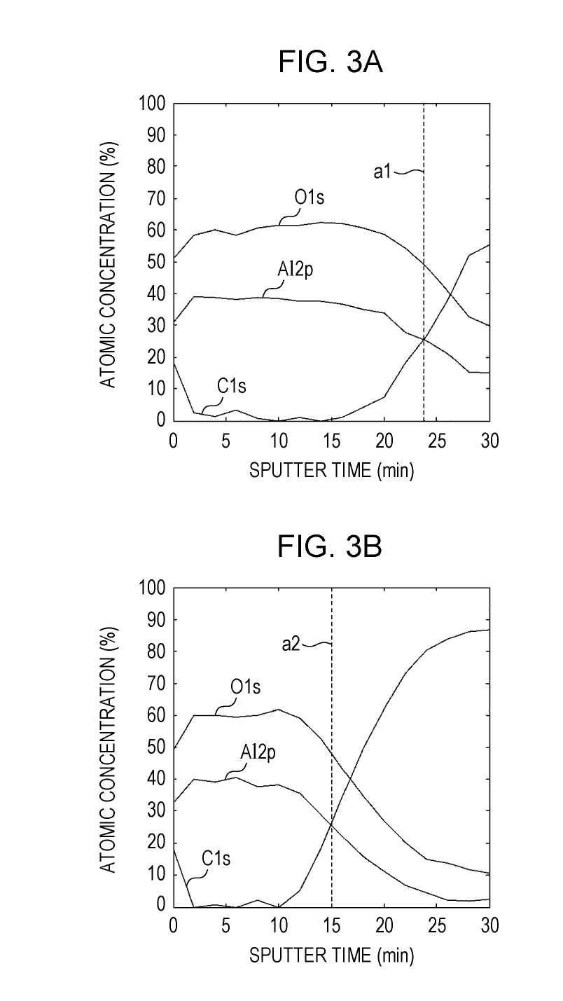

The gas barrier film in each of Example 1-1 and Comparative example 1-4 was subjected to surface analysis with electron spectroscopy for chemical analysis (ESCA) in order to make clear the mechanism of manifestation of the barrier property. FIGS. 3A and 3B show element detection data of ESCA. As shown in FIGS. 3A and 3B, a C peak was not detected from alumina and was detected from only the UC layer (resin layer). In Example 1-1 in which the barrier property was good, the etching time for detecting a C element (resin layer) was long, as indicated by a dotted line a1, whereas in Comparative example 1-4 in which the barrier property was poor, the etching time for detecting a C element (resin layer) was short, as indicated by a dotted line a2. Consequently, it was ascertained that in Example 1-1, the alumina layer thicker and wider than the alumina layer in Comparative example 1-4 was present.

Water Vapor Permeability Measurement

The water vapor permeability of the film produced in each of the examples and the comparative examples was measured as described below. That is, the water vapor permeability was measured under the condition of 40° C. and a relative humidity of 90% by using a water vapor permeation apparatus (model 7002) produced by Illinoi as a water vapor permeability measuring apparatus. The measurement results are shown in Table 1.

TABLE 1

| | Paint | | | |
|---|---|---|---|---|
| | Resin | | | Barrier value |
| | material | Additive | Initiator | (g/m²/d) |
| Example 1-1 | DCPA | — | Irgacure 184 | 0.013 |
| Example 1-2 | CB-1 | — | Irgacure 184 | less than 0.001 |
| Example 2-1 | DCPA | P-1A | Irgacure 184 | 0.005 |
| Example 2-2 | CB-1 | P-1A | Irgacure 184 | less than 0.001 |
| Example 2-3 | DCPA | — | Irgacure 127 | 0.007 |
| Example 2-4 | DCPA | — | Esacure KIP 150 | 0.002 |
| Example 2-5 | DCPA | — | ESACURE ONE | less than 0.001 |
| Example 2-6 | SR285 | — | ESACURE ONE | 0.008 |
| Example 2-7 | CD406 | — | ESACURE ONE | 0.013 |
| Comparative | TMPTA | — | Irgacure 184 | 0.5 |
| example 1-1 | | | | |
| Comparative | TMMT | — | Irgacure 184 | 1.8 |
| example 1-2 | | | | |
| Comparative | CN997 | — | Irgacure 184 | 1.8 |
| example 1-3 | | | | |
| Comparative | M215 | — | Irgacure 184 | 1.8 |
| example 1-4 | | | | |
| Comparative | ABE300 | — | Irgacure 184 | 0.045 |
| example 1-5 | | | | |
| Comparative | A-BPEF | — | Irgacure 184 | 0.022 |
| example 1-6 | | | | |
| Comparative | CBX-1N | — | Irgacure 184 | 1.1 |
| example 1-7 | | | | |

As shown in Table 1, in Example 1-1 in which the acrylate having a cycloalkane structure was used and Example 1-2 in which the acrylate having a high-acid value phthalic acid structure was used, high barrier properties were exhibited. These acrylate having a cycloalkane structure and acrylate having a high-acid value phthalic acid structure were able to be used in combination with the additive, 2-acryloyloxyethyl acid phosphate (P-1A, produced by Kyoeisha Chemical Co., Ltd.), having a function as a metal imparting agent. The barrier property was further improved by the use in combination. According to Example 2-3 to Example 2-5, the barrier property was not adversely affected by the use of various types of initiators and, in addition, the barrier property was further improved by the use of the low-volatile initiator. Moreover, high barrier properties were also exhibited in Example 2-6 in which the acrylate having an oxygen-containing hydrocarbon ring structure and Example 2-7 in which another acrylate having a cycloalkane structure was used. On the other hand, the barrier property was not manifested or a low barrier property was exhibited in Comparative example 1-1 and Comparative example 1-2 in which acrylates having neither ring structure nor acid group were used, Comparative example 1-3 in which the acrylate having a benzene ring was used, Comparative example 1-4 in which the acrylate containing isocyanuric acid was used, and Comparative example 1-7 in which the acrylate having a low-acid value phthalic acid structure was used. Consequently, it was ascertained that a compound having a cycloalkane structure or a compound having a high-acid value phthalic acid structure was important to manifest a high barrier property. The above description is contradictory to those described in Japanese Unexamined Patent Application Publication No. 2010-30292 and the like shown in the section of “Background”. That is, it is shown that “a film exhibiting a high barrier property does not necessarily contain a compound having a benzene-ring structure”.

Evaluation of Surface Roughness Depending on Type of Initiator

The surface roughness, the arithmetic average roughness (Ra), the maximum height (Rz), and the protrusion height of each of Example 1-1, Example 2-3, Example 2-4, and Example 2-5 were measured before and after evacuation as described below. The surface of the PEN film base material was subjected to the measurement in the same manner as a reference example.

Surface Roughness Measurement

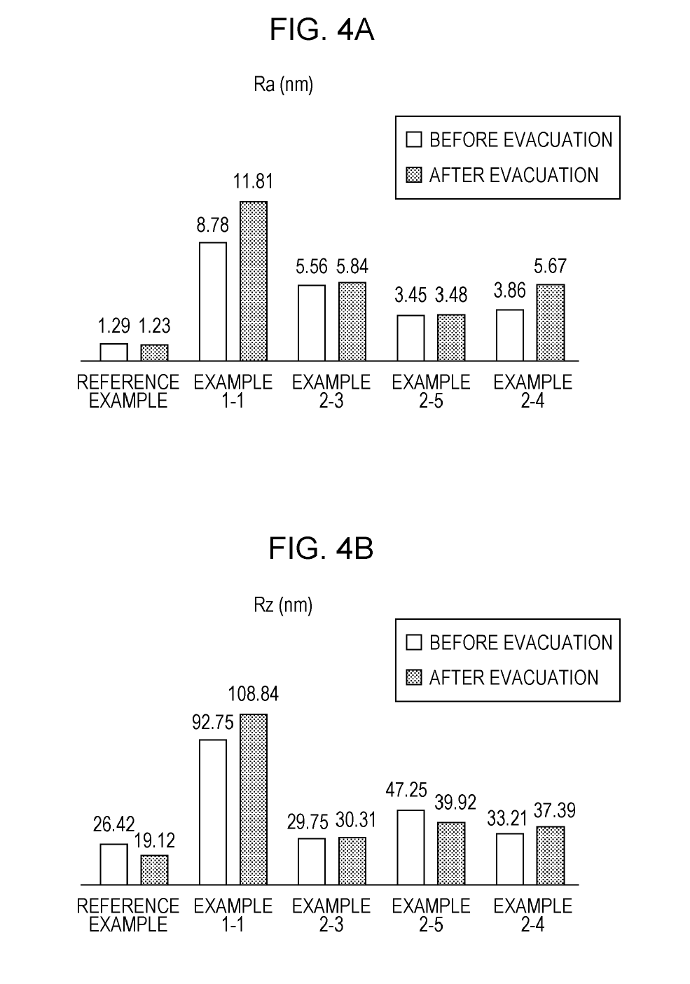

The Ra, the Rz, and the protrusion height in 0.140×0.100 μm were measured by using SPM (Nano Scope IIIa/D-3000, Digital Instruments). The measurement results are shown in Table 2 and FIGS. 4A and 4B.

TABLE 2

| | Before evacuation | | | After evacuation | | |
|---|---|---|---|---|---|---|
| | | | Pro- | | | Pro- |
| | | | trusion | | | trusion |
| | Ra | Rz | height | Ra | Rz | height |
| | (nm) | (nm) | (nm) | (nm) | (nm) | (nm) |
| Example | 8.78 | 92.75 | 75 | 11.81 | 108.84 | 76 |
| 1-1 | | | | | | |
| Example | 5.56 | 29.75 | 24 | 5.84 | 30.31 | 25 |
| 2-3 | | | | | | |
| Example | 3.86 | 33.21 | 19 | 5.67 | 37.39 | 21 |
| 2-4 | | | | | | |
| Example | 3.45 | 47.25 | 23 | 3.48 | 39.92 | 24 |
| 2-5 | | | | | | |
| Reference | 1.29 | 26.42 | 24 | 1.23 | 19.12 | 14 |
| example | | | | | | |

As shown in Table 2 and FIGS. 4A and 4B, Example 2-3 to Example 2-5, in which low-volatile initiators were used, were excellent in smoothness of the surface of resin layer as compared with Example 1-1, in which a high-volatile initiator was used and, thereby, the barrier properties were excellent. Example 2-4 and Example 2-5 were excellent in smoothness of the surface of resin layer as compared with Example 2-3 and, thereby, the barrier properties were more excellent.

### 2. Other Embodiments

The present disclosure is not limited to the above-described embodiments according to the present disclosure, and various modifications and applications can be made within the bounds of not departing from the gist of the present disclosure. For example, the numerical values, the structures, the shapes, the materials, the raw materials, the processes, and the like mentioned in the above-described embodiments and examples are no more than examples. The numerical values, the structures, the shapes, the materials, the raw materials, the processes, and the like different from them may be employed, as necessary. For example, the resin compositions according to the embodiments of the present disclosure may contain polymerizable compounds other than the above-described polymerizable compounds having a cycloalkane structure, polymerizable compounds having a high-acid value phthalic acid structure, and additives within the bounds of not departing from the gist of the present disclosure.

In Examples 4 and 8 in Japanese Unexamined Patent Application Publication No. 2010-30292 shown in the section of “Background”, the barrier property of 10⁻⁴ g/m²/d is not manifested unless 30 percent by weight of phosphoric acid is added. However, according to the findings of the engineers of the present disclosure, it is estimated that breakage occurs during the water vapor permeability measurement by using the water vapor permeation apparatus (model 7002) produced by Illinoi. In addition, reduction in hardness is also estimated. In Japanese Unexamined Patent Application Publication No. 2010-30290, the adhesion does not become good unless phosphoric acid (meth)acrylate is added. However, according to the findings of the engineers of the present disclosure, it is estimated that breakage occurs during the water vapor permeability measurement by using the water vapor permeation apparatus (model 7002) produced by Illinoi. As for Japanese Unexamined Patent Application Publication No. 2010-89502, the triphenylene skeleton product is expensive and, therefore, the productivity is poor. There is no data on the adhesion. As for Japanese Unexamined Patent Application Publication No. 2009-95989, a load on a production process is large because of the multilayer structure. As for Japanese Unexamined Patent Application Publication No. 2010-6064, there is no data on the adhesion.

The inorganic oxide layer 3 is not specifically limited insofar as the barrier property is manifested, and may be a thin film of a metal compound, e.g., a metal nitride, a metal carbide, a metal oxynitride, or a metal oxycarbide. Concrete examples of such metal compounds include nitrides, carbides, oxynitrides, and oxycarbides containing at least one type of metal element selected from the group consisting of Si, Al, In, Sn, Zn, Ti, Cu, Ce, and Ta. They may contain other elements as secondary components.

The present disclosure may adopt the following configurations.

[1] A gas barrier base material including a base material, a resin layer disposed on at least one principal surface of the base material, and an inorganic oxide layer which is disposed on one principal surface of the resin layer and which contains an inorganic oxide, wherein the above-described resin layer is produced by curing a resin composition containing a polymerizable compound having a cycloalkane structure or a polymerizable compound having a high-acid value phthalic acid structure.
[2] The gas barrier base material according to the item [1], wherein the above-described polymerizable compound having a cycloalkane structure is a polymerizable compound represented by General formula (A),

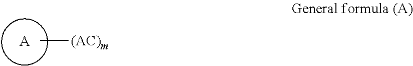

in the formula, A represents an aliphatic hydrocarbon ring which may contain oxygen, the aliphatic hydrocarbon ring may have a substituent, Ac represents a photopolymerizable functional group, and m represents 1 or 2.
[3] The gas barrier base material according to the item [1] or [2], wherein the above-described polymerizable compound having a high-acid value phthalic acid structure is a polymerizable compound represented by General formula (B),

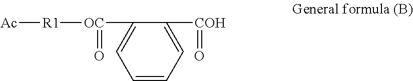

in the formula, R1 represents a divalent hydrocarbon group having the carbon number of 1 to 3 and Ac represents a photopolymerizable functional group.
[4] The gas barrier base material according to the item [2], wherein the polymerizable compound represented by General formula (A) described above is at least one type selected from acrylates represented by Formula (1) to Formula (3).

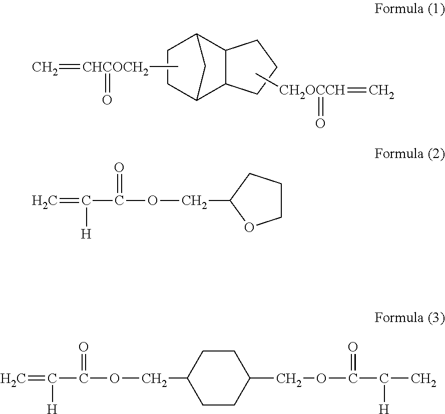

[5] The gas barrier base material according to the item [3], wherein the polymerizable compound represented by General formula (B) described above is an acrylate represented by Formula (4).

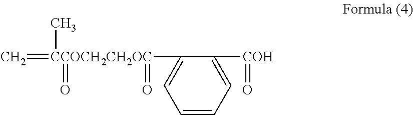

[6] The gas barrier base material according to any one of the items [1] to [5], wherein the above-described resin composition further contains a phosphoric acid acrylate as an additive and the above-described phosphoric acid acrylate is a compound represented by Formula (5).

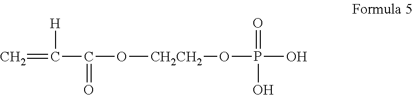

[7] The gas barrier base material according to any one of the items [1] to [6], wherein the above-described resin composition further contains an initiator and the above-described initiator contains a compound represented by Formula (6) or Formula (7),

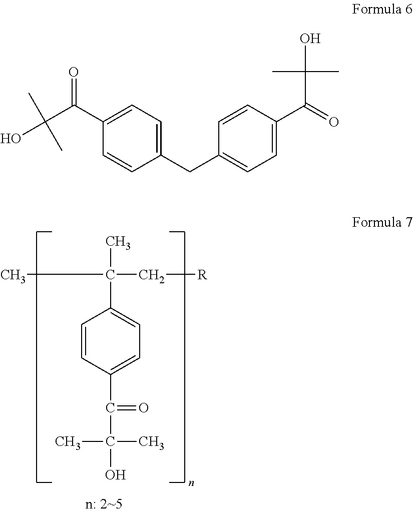

in the formula, R represents an ethyl group.
[8] The gas barrier base material according to any one of the items [1] to [7], wherein the above-described inorganic oxide is a metal oxide.
[9] The gas barrier base material according to the item [8], wherein the above-described metal oxide is alumina.
[10] The gas barrier base material according to any one of the items [1] to [9], wherein the above-described base material is a plastic film.
[11] The gas barrier base material according to the item [10], wherein the above-described plastic film is a polyethylene naphthalate film.
[12] A gas barrier laminate including a resin layer and an inorganic oxide layer which is disposed on one principal surface of the resin layer and which contains an inorganic oxide, wherein the above-described resin layer is produced by curing a resin composition containing a polymerizable compound having a cycloalkane structure or a polymerizable compound having a high-acid value phthalic acid structure.

The present disclosure contains subject matter related to that disclosed in Japanese Priority Patent Application JP 2011-260769 filed in the Japan Patent Office on Nov. 29, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A gas barrier base material comprising:
a base material;
a resin layer disposed on at least one principal surface of the base material; and
an inorganic oxide layer which is disposed on one principal surface of the resin layer and which contains an inorganic oxide,
wherein the resin layer is produced by curing a resin composition containing a polymerizable compound having a cycloalkane structure or a polymerizable compound having a high-acid value phthalic acid structure.

2. The gas barrier base material according to claim 1,
wherein the polymerizable compound having a cycloalkane structure is a polymerizable compound represented by General formula (A), 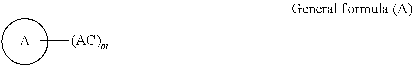
in the formula, A represents an aliphatic hydrocarbon ring which may contain oxygen, the aliphatic hydrocarbon ring may have a substituent, Ac represents a photopolymerizable functional group, and m represents 1 or 2.

3. The gas barrier base material according to claim 1,
wherein the polymerizable compound having a high-acid value phthalic acid structure is a polymerizable compound represented by General formula (B), 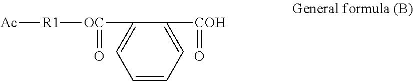
in the formula, R1 represents a divalent hydrocarbon group having the carbon number of 1 to 3 and Ac represents a photopolymerizable functional group.

4. The gas barrier base material according to claim 2,
wherein the polymerizable compound represented by General formula (A) is at least one type selected from acrylates represented by Formula (1) to Formula (3).

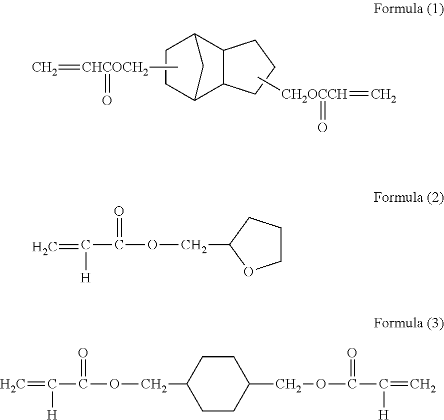

5. The gas barrier base material according to claim 3,
wherein the polymerizable compound represented by General formula (B) is an acrylate represented by Formula (4).

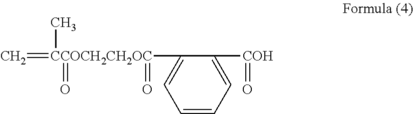

6. The gas barrier base material according to claim 1,
wherein the resin composition further contains a phosphoric acid acrylate as an additive and
the phosphoric acid acrylate is an acrylate represented by Formula (5).

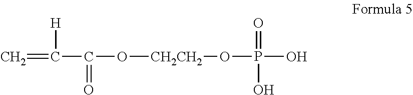

7. The gas barrier base material according to claim 1,
wherein the resin composition further contains an initiator and
the initiator contains a compound represented by Formula (6) or Formula (7), 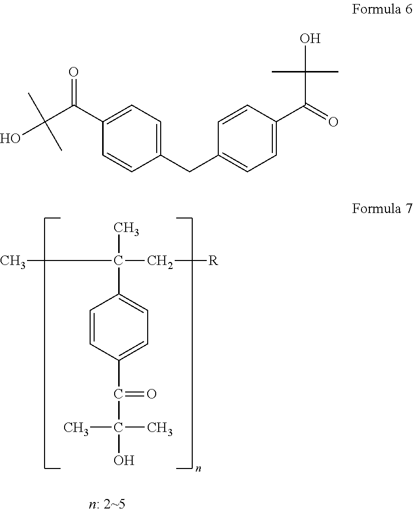
in the formula, R represents an ethyl group.

8. The gas barrier base material according to claim 1,
wherein the inorganic oxide is a metal oxide.

9. The gas barrier base material according to claim 8,
wherein the metal oxide is alumina.

10. The gas barrier base material according to claim 1,
wherein the base material is a plastic film.

11. The gas barrier base material according to claim 10,
wherein the plastic film is a polyethylene naphthalate film.

12. A gas barrier laminate comprising:
a resin layer; and
an inorganic oxide layer which is disposed on one principal surface of the resin layer and which contains an inorganic oxide,
wherein the resin layer is produced by curing a resin composition containing a polymerizable compound having a cycloalkane structure or a polymerizable compound having a high-acid value phthalic acid structure.
